(19) United States
(12) Patent Application Publication
(10) Pub. No.: US 2004/0169772 A1
(43) Pub. Date: Sep. 2, 2004

(54) Camera

(75) Inventors: Kazuaki Matsui, Osaka (JP); Yoshito Iwasawa, Tokyo (JP); Satoshi Yokota, Osaka (JP); Yoshihiro Hara, Osaka (JP); Akira Kosaka, Osaka (JP); Sadanobu Ueda, Osaka (JP)

Correspondence Address: MCDERMOTT, WILL & EMERY, 600 13th Street, N.W., WASHINGTON, DC, 20005-3096, US

(73) Assignee: MINOLTA CO., LTD.

(21) Appl. No.: 10/446,792

(22) Filed: May 29, 2003

(30) Foreign Application Priority Data
Feb. 18, 2003 (JP) 2003-39119

(51) Int. Cl. H04N 5/225

(52) U.S. Cl. 348/375

(57) ABSTRACT

A camera, as soon as the user finishes using it, quickly assumes a not-in-use appearance that the camera is designed to assume when it is out of operation. The camera incorporates, inside its body, a taking optical system including a turning optical system for turning the optical path of the light from a shooting target substantially at a right angle and a zoom optical system for varying shooting magnification. The body has an opening through which the front face of the taking optical system is exposed, and has a barrier for closing the opening. The camera, when a command to stop operation is given, performs the process of closing the barrier with highest priority, and then performs the process of extinguishing display with second highest priority. The camera, now having assumed an appearance that it is supposed to assume when out of operation, then performs other, internal, processes for stopping operation.

This application is based on Japanese Patent Application No. 2003-39119 filed on Feb. 18, 2003, the contents of which are hereby incorporated by reference.

### BACKGROUND OF THE INVENTION

1. Field of the Invention

The present invention relates to processes performed when a camera stops and starts being used.

2. Description of the Prior Art

Some cameras are designed to be slim and compact when not in use as a result of their taking optical system being designed to be entirely or partially housed inside their body. Such cameras have been becoming increasingly popular. In this type of camera, when the camera starts being used, i.e., when it starts operating, the taking optical system is moved forward out of the body so as to be positioned at a shooting position, and, when the camera stops being used, i.e., when it stops operating, the taking optical system is moved backward so as to be housed inside the body. In many cameras of this type, the taking optical system is moved electrically, though there are some that require their user to move the taking optical system manually.

On the other hand, it used to be common to put a cap to a taking optical system to protect its front when it is not in use. Nowadays, many cameras are instead provided with an openable-closable barrier in front of the taking optical system. This barrier is opened at the time of shooting, and is closed when no shooting is performed. In cameras in which the taking optical system is entirely housed inside the body, the barrier is provided in the body. This barrier is opened when the camera is used, and is closed when the camera is not in use. These barriers are opened and closed manually or electrically.

In a camera in which the housing of the taking optical system inside the body, the positioning thereof at the shooting position, and the opening and closing of the barrier are achieved electrically, the movement of the taking optical system is usually interlocked with the opening and closing of the barrier, as proposed in U.S. Pat. No. 6,212,335 and Japanese Patent Application Laid-Open No. 2001-5050. When the user stops using the camera, he or she first makes sure that the taking optical system is housed inside the body and the barrier is closed, and then puts the camera in a case or bag.

In this type of camera, the time required for start-up, i.e., the time required after the user gives a command to start the supply of electric power until the camera becomes ready to operate as a camera, is mostly spent to wait for the taking optical system to move to the shooting position. In a case where the taking optical system is a zoom optical system, the time required for start-up is minimized by moving the taking optical system, at start-up, to the position corresponding to the minimum shooting magnification (the maximum angle of view), i.e., the position at the least distance for the taking optical system to travel from its housed position.

Likewise, the time required for shut-down, i.e., the time required after the user gives a command to stop the supply of electric power until electric power actually stops being supplied, is mostly spent to wait for the taking optical system to move to the housed position. In a case where a zoom optical system is used, at the time point that the user gives a command to stop the supply of electric power, the taking optical system is not always located at the position corresponding to the minimum shooting magnification. Accordingly, it usually takes longer time to complete shut-down than to complete start-up.

Entirely or partially housing the taking optical system inside the body is advantageous from the viewpoint of making the camera easily portable, but is disadvantageous from the viewpoint of making the time required for start-up and shut-down longer. In particular, the time required for shut-down is undesirable for a user who wants to put the camera in a case or bag as soon as he or she has finished using it.

In cameras in which the taking optical system is not designed to be housed inside the body, it takes little time to complete start-up or shut-down. However, in a construction in which a barrier is electrically opened and closed, if the process of closing the barrier takes time at the end of camera operation, the user cannot immediately put the camera in a case or the like. Nevertheless, conventionally, this has not been taken into consideration, and the process of closing the barrier is handled in rather a late stage among the various processes performed at the end of camera operation.

In a camera provided with a display for displaying various kinds of information, or in a digital camera furnished with the function of displaying taken pictures, when the camera stops operating, quite naturally its display is extinguished. Even before the process of extinguishing the display is completed, the user can put the camera in a case or the like, and doing so does not harm the camera in any way so long as the display is extinguished after the camera has been put away. Here, however, the user feels uneasy because, although he or she has given a command to stop camera operation, the camera does not readily stops operating. The user may mistakenly conclude that he or she, through inappropriate operation, has failed to give a command to stop camera operation. In this case, the user tries giving a command to stop camera operation once again. Usually, a command to stop camera operation and a command to start camera operation are assigned to a single switch, and therefore operating this switch once again results in giving a command to start camera operation, causing the camera to start operating again.

### SUMMARY OF THE INVENTION

An object of the present invention is to provide a camera that, as soon as the user finishes using it, quickly assumes a not-in-use appearance that the camera is supposed to assume when it is out of operation. Another object of the present invention is to provide a digital camera that includes a zoom optical system as a taking optical system but that nevertheless permits quick starting of shooting

To achieve the above objects, according to one aspect of the present invention, a camera is provided with: an image-sensing portion for sensing an image; a taking optical system for directing light to the image-sensing portion, an operation portion for accepting a command to start camera operation and a command to stop camera operation; an openable-closable shielding member that is closed when the camera is out of operation so as to shield the front face of the taking optical system; and a controller portion that, when a command to stop camera operation is given while the camera is in operation, performs a plurality of processes for stopping camera operation including the process of closing the shielding member. Here, the controller portion performs, among the plurality of processes for stopping camera operation, the process of closing the shielding member with highest priority.

By performing the process of closing the barrier first, it is possible to reduce the time that the camera takes to come into a state in which it can be put in a case or bag. Unless the taking optical system is designed to be housed inside the body when the camera is out of operation and put outside the body when the camera is in operation, it is possible even to put the camera in a case or the like immediately.

Here, the taking optical system may include a turning optical system that reflects light and thereby turns the optical path substantially at a right angle and a zoom optical system that is disposed between the turning optical system and the image-sensing portion and that varies the shooting magnification. The movable lens of the zoom optical system then moves not in the front-rear direction but in a direction perpendicular thereto. This makes the front-rear dimension of the taking optical system constant, and thus makes it possible to house the entire taking optical system inside the body so that the taking optical system does not protrude from the body. In this way, it is possible to give the camera a compact shape that makes the camera convenient to carry around, and permits the camera to be put in a case or the like immediately after a command to stop its operation is given.

The camera may be further provided with an indicator portion that, when the processes for stopping camera operation are being performed, indicates that the processes for stopping camera operation are being performed. This helps prevent the user from performing inappropriate operation that may hamper the processes being performed. It is also possible to leave a portion of the camera to maintain the in-use appearance even after the barrier is closed. This permits the user to confirm and be thereby given assurance that the camera automatically stops operating.

The camera may be further provided with a display portion for achieving predetermined display when the camera is in operation. In this case, the controller portion performs, among all the processes for stopping camera operation, the process of stopping the display on the display portion parallel with the process of closing the shielding member or with second highest priority to the process of closing the shielding member. In a case where the camera is provided with no indicator portion, if display persists even after the barrier is closed, the user may feel uneasy, fearing that the camera might fail to stop operating. This can be avoided by promptly distinguishing the display.

The plurality of processes for stopping camera operation which are performed by the controller portion may include the process of completing recording of image data representing a taken picture on a recording medium or the process of terminating communication with an external device. This makes it possible to securely record image data that has not yet been recorded completely, or to prevent communication with the external device from being broken unexpectedly.

The camera may be further provided with a power supply portion for supplying electric power to portions of the camera that operate on electric power. In this case, the operation portion includes a main switch for accepting a command to start and a command to stop the supply of electric power from the power supply portion. In this configuration, operating the main switch produces a command to stop camera operation.

According to another aspect of the present invention, a camera that has different appearances between when in operation and when out of operation is provided with: an image-sensing portion for sensing an image; a taking optical system for directing light to the image-sensing portion; an operation portion for accepting at least a command to stop camera operation; and a controller portion that, when a command to stop camera operation is given while the camera is in operation, performs a plurality of processes for stopping camera operation. Here, the controller portion performs, among the plurality of processes for stopping camera operation, a process that brings about a change in appearance with highest priority, and then, after the camera has assumed the appearance that the camera is designed to assume when out of operation, performs one or more processes that bring about no change in appearance.

This camera, when given a command to stop camera operation, performs a plurality of processes for stopping camera operation. Among the plurality of processes performed here, the process of making the camera assume the not-in-use appearance that the camera is supposed to assume when not in use is performed not in the last stage but in an earlier stage, and thereafter the other, internal, processes that bring about no change in appearance are performed. The process that brings about a change in appearance may be performed parallel with part of the processes that bring about no change in appearance.

According to still another aspect of the present invention, a digital camera is provided with: an image sensor for sensing an image; a taking optical system for directing light to the image sensor, the taking optical system including a turning optical system for turning the optical path and a zoom optical system, disposed between the turning optical system and the image sensor, for varying the shooting magnification; a driver portion for driving a movable lens of the zoom optical system; a storage portion for storing the position of the movable lens of the zoom optical system; an operation portion for accepting a command to start shooting operation and a command to stop shooting operation; and a controller portion for controlling the driver portion to drive the movable lens of the zoom optical system while detecting the position of the movable lens of the zoom optical system. Here, when a command to stop shooting operation is given, the controller portion makes the storage portion store the position of the movable lens at that time point, and, when a command to start shooting operation is given, the controller portion controls driving of the movable lens according to the position stored in the storage portion.

In this digital camera, when shooting operation is stopped, the position of the movable lens of the zoom optical system is stored, and the position thus stored is used to control the driving of the movable lens when shooting operation is started. This makes it possible to quickly stop shooting operation in response to a command to stop shooting operation, and to precisely perform the control necessary at the start of shooting operation, for example the control for placing the movable lens of the zoom optical system and the focus lens in a predetermined relationship with each other. Moreover, it takes little time to start shooting operation.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a perspective view of a digital camera embodying the invention;

FIG. 2 is a rear view of the digital camera;

FIGS. 3A and 3B are sectional views showing the optical construction of the digital camera;

FIGS. 4A and 4B are sectional views showing the mechanism for moving the movable lenses of the zoom lens group of the digital camera;

FIG. 5 is a front view of a portion around the opening formed in the body of the digital camera;

FIG. 6 is a block diagram showing an outline of the circuit configuration of the digital camera;

FIG. 7 is a diagram schematically showing the mechanism for detecting the position of the movable lenses of the zoom lens group of the digital camera;

FIG. 8 is a diagram showing the relationship observed in the digital camera between the driving pulses of the motor for driving the movable lenses of the zoom lens group and the output signal of the photoreflector for detecting the position of the movable lenses;

FIG. 9 is a diagram schematically showing the mechanism for driving the barrier of the digital camera,

FIG. 10 is a flow chart showing an outline of the flow of processes performed in the mode for taking still pictures in the digital camera, starting with start-up and ending with shut-down; and

FIG. 11 is a flow chart showing the modified portion of a partially modified version of the flow of processes shown in FIG. 10.

### DESCRIPTION OF THE PREFERRED EMBODIMENTS

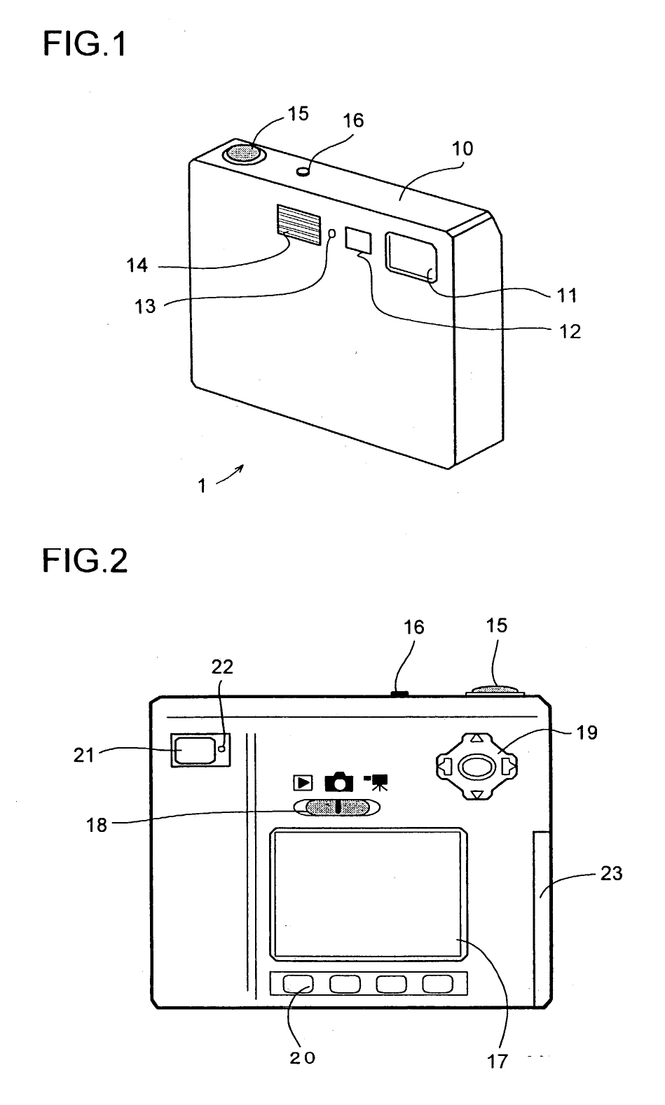

Hereinafter, a digital camera embodying the present invention will be described with reference to the drawings. FIG. 1 is a perspective view of the digital camera 1 embodying the invention, as seen obliquely from the front, and FIG. 2 is a rear view thereof. The digital camera 1 has a body 10 in the shape of a box slim in the front-rear direction, and has a taking optical system and an image sensor, which will be described later, housed inside the body 10.

In an upper portion of the front face of the body 10, there is formed an opening 11 through which the front face of the taking optical system is exposed. By the side of the opening 11, there are arranged, side by side, an optical viewfinder 12, a metering sensor 13, and a flash emitter 14. On the top face of the body 10, there are provided a shutter-release button 15 and a main switch 16. The shutter-release button 15 is operated to give a command to record a taken picture, and the main switch 16 is operated to give a command to start and stop the operation of the digital camera 1 as a whole, i.e., to start and stop the supply of electric power from a power supply.

On the back face of the body 10, there are provided a display 17 composed of an LCD, an operation switch 18 of the sliding type, an operation key 19 having four contacts, a plurality of operation buttons 20, an eyepiece window 21 of the optical finder 12, and an LED lamp 22. Also provided on the back face is a lid 23 that reaches the side face. Inside the body 10, near the lid 23, there are formed a slot in which to insert a removable memory card for recording taken pictures and a slot in which to insert a rechargeable battery that serves as the power source of the digital camera 1. The lid 23 covers the memory card and the battery inserted in these slots.

The digital camera 1 operates in one of the following three modes: the camera mode for taking still pictures, the movie mode for shooting moving pictures, and the playback mode for playing back pictures recorded on the memory card to display them. The operation switch 18 is operated to switch among these modes. Near the operation switch 18, there are marked three icons symbolizing the three modes.

On the display 17 are displayed the current settings of the digital camera 1, operation guides, the image that is currently being sensed or has just been taken, and recorded images. The display 17, by immediately displaying the image currently being sensed, provides a live view and thereby functions as an electronic viewfinder.

In the camera mode and in the movie mode, the operation key 19 is operated to perform zooming, i.e., to vary the shooting magnification and, when a guide for setting shooting conditions is displayed on the display 17, also to select a parameter from among those shown in the guide. In the playback mode, the operation key 19 is operated to select a picture to be played back. The operation buttons 20 are operated to turn on and off the display of operation guides, and to set the selected parameter.

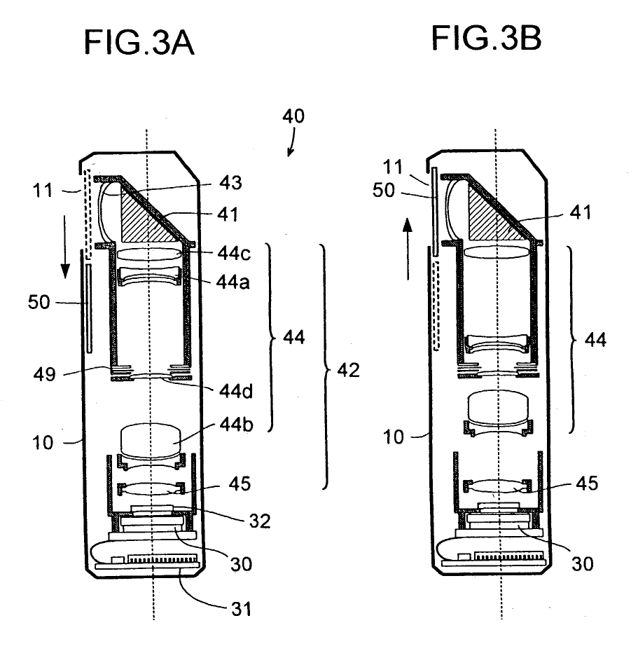

FIGS. 3A and 3B are sectional views showing the optical construction of the digital camera 1. FIGS. 3A and 3B show different states of the digital camera 1. The digital camera 1 is provided with an image sensor 30 that senses an image by converting light into an electrical signal and a taking optical system 40 that directs the light from a shooting target to the image sensor 30 to image it on the image sensor 30. Used as the image sensor 30 is a CCD-type area sensor. The image sensor 30 has a large number of pixels that selectively receive red (R), green (G), and blue (B) light. The image sensor 30 is disposed in a lower portion of the body 10 so as to receive light from above.

The taking optical system 40 is composed of a turning optical system 41 that reflects the light from the shooting target and thereby turns the optical path of the light substantially at a right angle, a zoom optical system 42, and an objective lens 43. The turning optical system 41 is so disposed as to face the opening 11 and turn the optical path downward. Used as the turning optical system 41 is a rectangular prism having a reflective film laid on the slant surface thereof. Instead of a prism, it is also possible to use as the turning optical system 41 any other type of optical element that turns the optical path of light, such as a simple mirror. The objective lens 43 is disposed between the opening 11 and the turning optical system 41.

The zoom optical system 42 is disposed between the turning optical system 41 and the image sensor 30. The optical axis of the zoom optical system 42 runs through the center of the reflective surface of the turning optical system 41, forming an angle of 45° relative to the reflective surface, and runs through the center of the image sensor 30, crossing it at right angles.

The zoom optical system 42 is composed of a zoom lens group 44 for varying the shooting magnification and a focus lens group 45 for adjusting the focus. The zoom lens group 44 includes movable lenses 44a and 44b that are movable along the optical axis and stationary lenses 44c and 44d that are kept stationary. The focus lens group 45 is movable along the optical axis. FIG. 3A shows the state of the zoom optical system 42 at the minimum shooting magnification (i.e., at the maximum angle of view), and FIG. 3B shows the state of the zoom optical system 42 at the maximum shooting magnification (i.e., at the minimum angle of view).

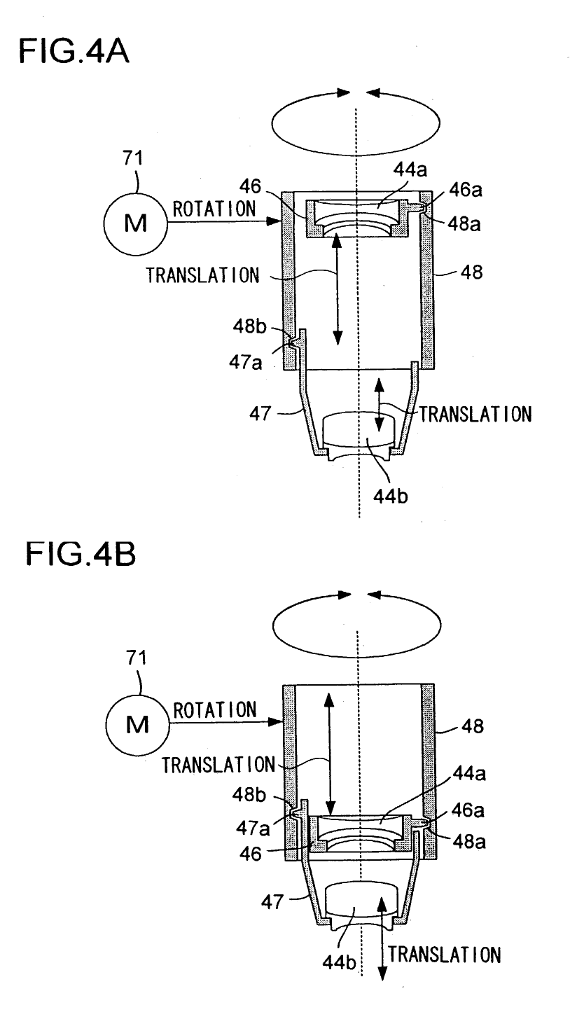

FIGS. 4A and 4B are sectional views showing the mechanism for moving the movable lenses 44a and 44b of the zoom lens group 44. The movable lenses 44a and 44b are held by separate lens barrels 46 and 47. The lens barrel 46 is housed inside a larger lens barrel 48, and part of the lens barrel 47 is also housed inside the lens barrel 48. On the outer circumferential surfaces of the lens barrels 46 and 47 are formed projections 46a and 47a, respectively, and in the inner circumferential surface of the lens barrel 48 is formed two spiral grooves 48a and 48b. The projection 46a of the lens barrel 46 fits in the groove 48a of the lens barrel 48 and makes contact with the wall surface thereof, and the projection 47a of the lens barrel 47 fits in the groove 48b of the lens barrel 48 and makes contact with the wall surface thereof.

The lens barrels 46 and 47 are both so supported as to be movable along the optical axis of the zoom optical system 42 but not rotatable about the optical axis. On the other hand, the lens barrel 48 is so supported as to be rotatable about the optical axis but not movable along the optical axis. The two grooves 48a and 48b of the lens barrel 48 spiral in opposite directions. The movement of the movable lenses 44a and 44b is achieved by rotating the lens barrel 48 with a motor 71, described later. As the lens barrel 48 rotates, the projection 46a slides along the inside of the groove 48a, causing the lens barrel 46 to move along the optical axis, and the projection 47a slides along the inside of the groove 48b, causing the lens barrel 47 to move along the optical axis. Since the grooves 48a and 48b spiral in opposite directions, the lens barrels 46 and 47 move in opposite directions. This permits the distance between the movable lenses 44a and 44b to vary and the shooting magnification to vary.

The pitches of the two grooves 48a and 48b of the lens barrel 48 are not constant, but are so set that the movable lenses 48a and 48b are always in an appropriate positional relationship with each other over the entire range of shooting magnification from the minimum to the maximum shooting magnification. FIG. 4A shows the position of the movable lenses 44a and 44b at the minimum shooting magnification, and FIG. 4B shows their position at the maximum shooting magnification.

The mechanism for moving the focus lens group 45 is likewise composed of a lens barrel that has a projection on the outer circumferential surface thereof and that is movable along the optical axis and a lens barrel that has a spiral grove in the inner circumferential surface thereof and that is rotatable about the optical axis.

As shown in FIG. 3A, in the vicinity of the stationary lens 44d, there is provided an aperture stop 49 of which the aperture diameter is variable. Between the zoom optical system 42 and the image sensor 30, close to the image sensor 30, there is disposed a low-pass filter 32, and below the image sensor 30 is disposed a driver 31 thereof.

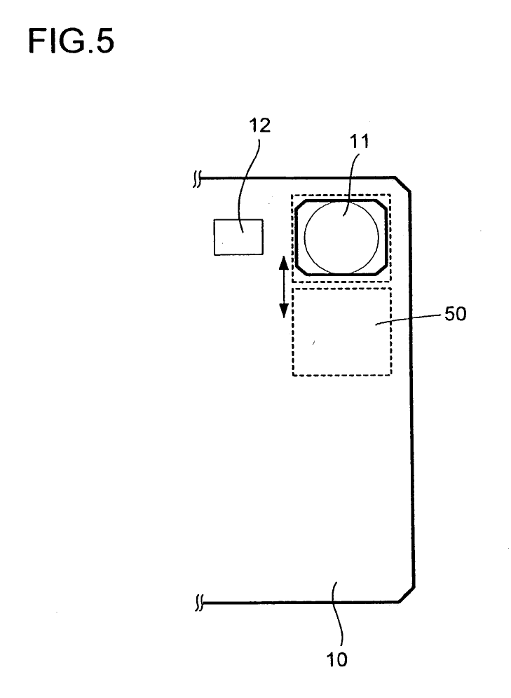

Inside the body 10, close to the opening 11, there is provided a barrier 50 that is movable in the up-down direction. FIG. 5 is a front view of a portion of the body 10 around the opening 11. When the barrier 50 is located at the lower end of the movable stroke thereof, it uncovers the front face of the taking optical system 40 and exposes it to outside through the opening 11. When the barrier 50 is located at the upper end of the movable stroke thereof, it covers the front face of the taking optical system 40 and protects it. FIGS. 3A and 3B respectively show the state in which the barrier 50 leaves the front face of the taking optical system 40 open and the state in which it keeps it closed. It is to be noted that FIGS. 3A and 3B happen to collectively show the relationship between the shooting magnification and the movable lens position of the zoom lens group 44 along with, though utterly independent thereof, the open and closed states of the barrier 50, and therefore these figures should not be regarded as showing the relationship between the movable lens position of the zoom lens group 44 and the open and closed state of the barrier 50.

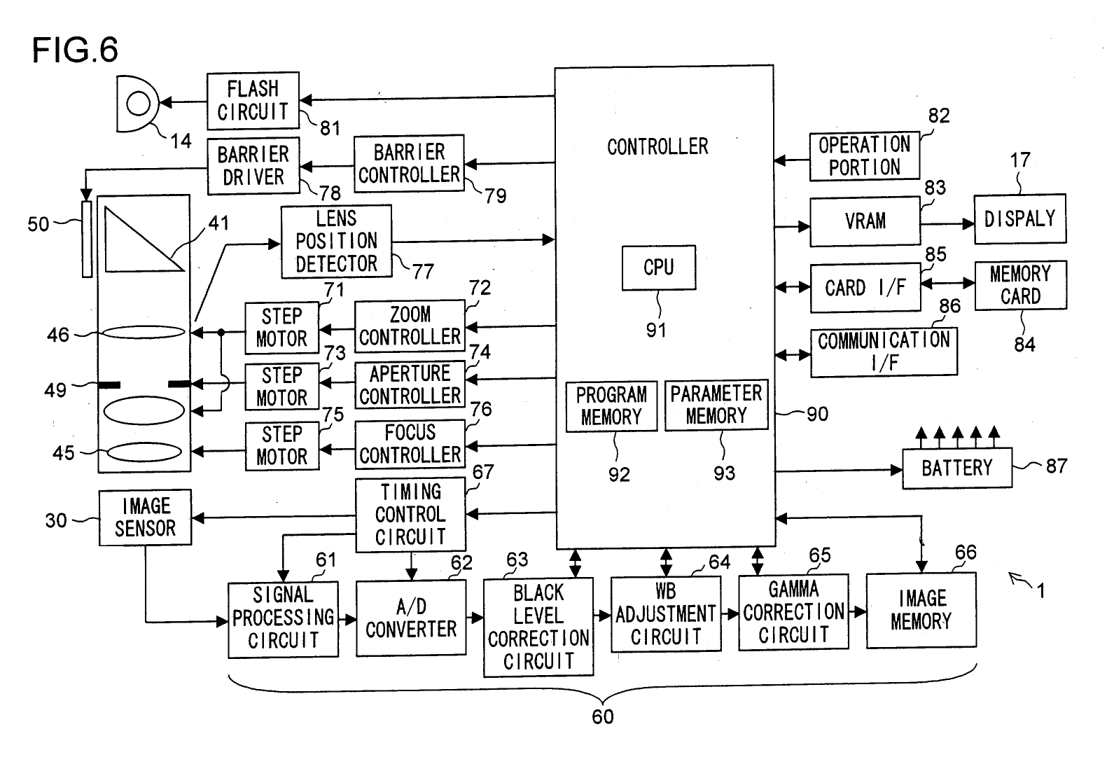

FIG. 6 shows an outline of the circuit configuration of the digital camera 1. The digital camera 1 is provided with a controller 90 that controls the operation of the digital camera 1 as a whole and an image processor 60 that produces image data representing an image sensed by the image sensor 30. The image processor 60 is composed of a signal processing circuit 61 that processes analog signals output from the individual pixels of the image sensor 30, an A/D converter 62 that converts the analog signals into digital signals, a black level correction circuit 63 that corrects the level of the digital signals as a whole, a white balance adjustment circuit 64 that adjusts the white balance (WB) of the image by adjusting the levels of three-color, i.e., R, G, and B, signals output from the three types of pixels of the image sensor 30, a gamma correction circuit 65 that performs nonlinear processing on the signals to make them suitable for display, and an image memory 66.

Through the processing performed by the circuit blocks starting with the signal processing circuit 61 and ending with the gamma correction circuit 65, image data representing an image is produced. The thus produced image data is then temporarily stored in the image memory 66. The image sensor 30, signal processing circuit 61, and A/D converter 62, which all handle analog signals, are so controlled as to operate in synchronism with one another by a timing control circuit 67.

The digital camera 1 is provided also with a stepping motor 71 that moves the movable lenses of the zoom lens group 44, a zoom controller 72 that controls zooming by driving the motor 71, a stepping motor 73 that opens and closes the aperture stop 49, an aperture controller 74 that controls the aperture diameter of the aperture stop 49 by driving the motor 73, a stepping motor 75 that moves the focus lens group 45, a focus controller 76 that adjusts the focus by driving the motor 75, a lens position detector 77 that detects the position of the movable lenses of the zoom lens group 44, a barrier driver 78 that moves the barrier 50, and a barrier controller 79 that controls the opening and closing of the barrier 50 through the barrier driver 78.

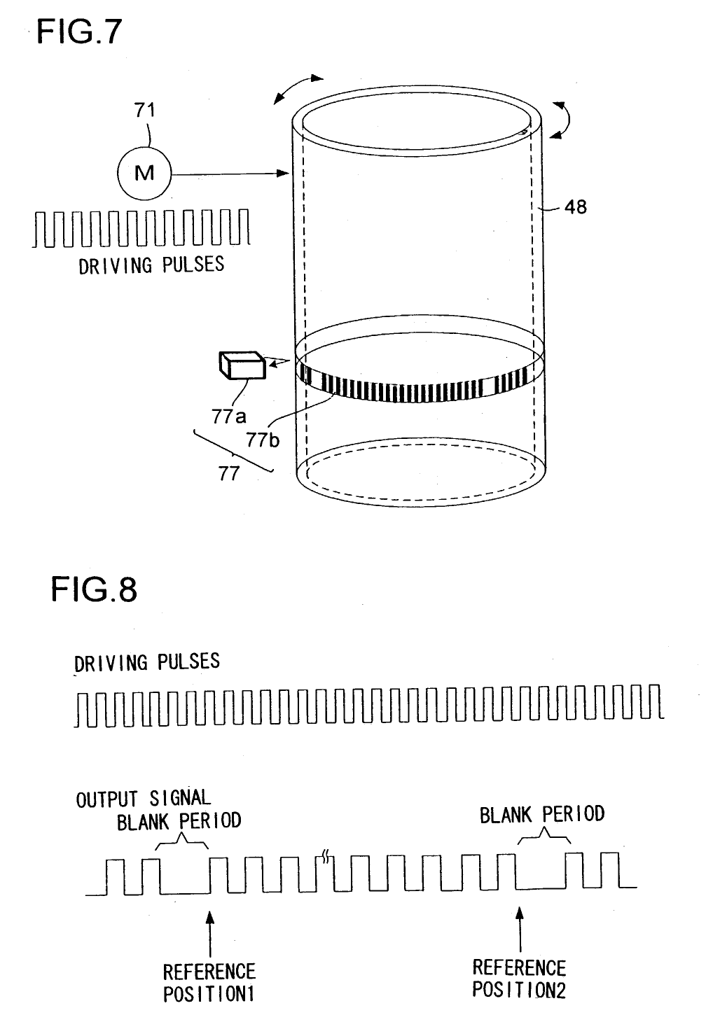

FIG. 7 shows the structure of the lens position detector 77. The lens position detector 77 is composed of a photoreflector 77a and a reflective pattern 77b that is formed in the shape of a strip around the outer circumferential surface of the lens barrel 48, which is rotatable about the optical axis. The photoreflector 77a emits light toward the reflective pattern 77b, and detects the light reflected from the reflective pattern 77b. The reflective pattern 77b has a large number of high-reflectivity patches and low-reflectivity patches arranged regularly around the circumference of the lens barrel 48. Along the circumference of the lens barrel 48, all the high-reflectivity patches are equally long, and most of the low-reflectivity patches are equally long, the length of these being equal to that of the high-reflectivity ones. That is, some of the low-reflectivity patches are made longer than the others so as to serve as the references with respect to which the position of the movable lenses of the zoom lens group 44 is determined.

FIG. 8 shows the relationship between the driving pulses output from the motor 71 and the output signal of the photoreflector 77a. The driving pulses of the motor 71 have a constant cycle, and the lens barrel 48 rotates at a constant rate. Accordingly, so long as the equally long low-reflectivity patches of the reflective pattern 77b are located where the reflective pattern 77b receives the light from the photoreflector 77a, the output signal of the photoreflector 77a also has a constant cycle. However, when the longer low-reflectivity patches reach where the reflective pattern 77b receives the light from the photoreflector 77a, the output signal of the photoreflector 77a exhibits a longer blank. The position where this longer blank ends is recognized as a reference, and, by counting the pulses in the output signal of the photoreflector 77a thereafter, the position of the movable lenses is determined accurately. The controller 90, while referring to the output signal of the photoreflector 77a of the lens position detector 77, controls the zoom controller 72.

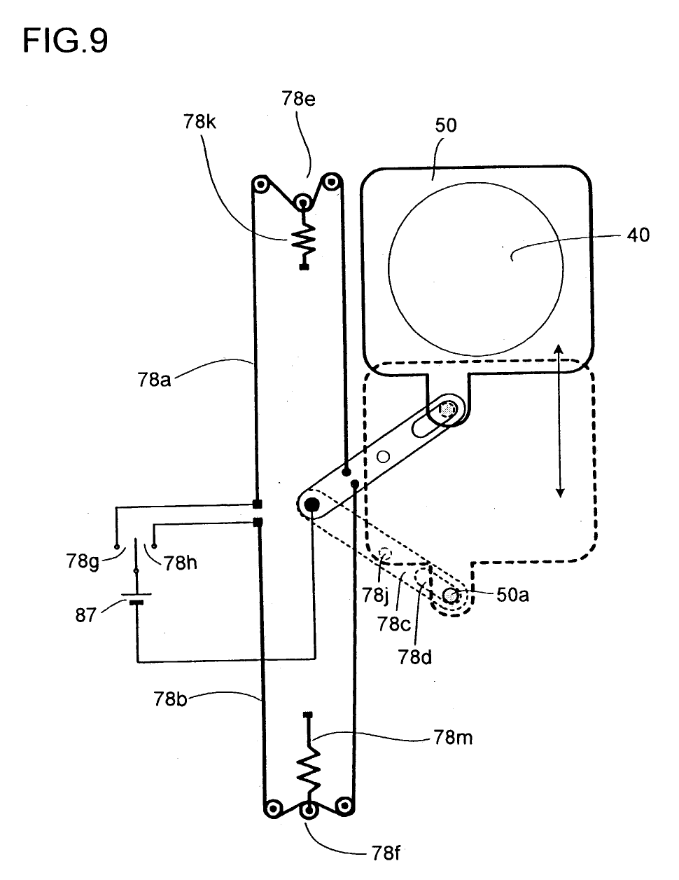

FIG. 9 shows the structure of the barrier driver 78. The barrier driver 78 is composed of two wires 78a and 78b made of a shape memory alloy and a lever 78c. The lever 78c has one end fitted to the body 10, and pivots on that end, with the other end moving in the up-down direction. The lever 78c has an elongate opening 78d formed in the other end, and through this opening 78d is placed a projection 50a that is provided on the barrier 50. As the lever 78c pivots, the barrier 50 moves in the up-down direction. The lever 78c is made of an electrically conductive material, for example a metal such as aluminum.

The wires 78a and 78b each have one end fixed to the body 10 and the other end fixed to the lever 78c. One wire 78a reaches the lever 78c from above by way of a pulley mechanism 78e provided in an upper portion of the body 10, and the other wire 78b reaches the lever 78c from below by way of a pulley mechanism 78f provided in a lower portion of the body 10.

The wires 78a and 78b have the property of contracting as temperature rises and restoring their original length at ordinary temperature. The wires 78a and 78b are each grounded at the end at which they are fitted to the lever 78c, and receive, at the end at which they are fitted directly to the body 10, a voltage from a battery 87 by way of switches 78g and 78h, respectively. When an electric current flows through the wire 78a or 78b, it generates heat and thereby contracts, causing the lever 78c to pivot upward or downward, respectively. The switches 78g and 78h are so switched that the voltage is applied to only one of the wires 78a and 78b at a time. The switches 78g and 78h both can be open at the same time.

The application of the voltage to the wires 78a and 78b, i.e., the opening and closing of the switches 78g and 78h, is controlled by the barrier controller 79. The barrier controller 79 closes the switch 78g or 78h only when flipping the barrier 50 from the open state to the closed state or from the closed state to the open state, respectively. Thus, the wires 78a and 78b are normally in an expanded state.

The lever 78c and the body 10 are provided with a snap mechanism that lightly engages them together to restrict the pivoting of the lever 78c when the barrier 50 is located at the upper and lower ends of the movable stroke thereof. Thus, even when the wires 78a and 78b are both in the expanded state, the barrier 50 does not move. This helps prevent electric power from being consumed simply to keep the barrier 50 in the closed or open state. The snap mechanism is composed of, for example, a small hemispherical projection 78j provided on the lever 78c and shallow depressions (not illustrated) formed in the body 10 to let the projection 78j snap in.

The purpose of providing the pulley mechanisms 78e and 78f to bend the wires 78a and 78b is to extend the wires 78a and 78b and thereby increase the difference in their length between in the expanded state at ordinary temperature and in the contracted state resulting from the heat they generate. This serves to make the movable stroke of the barrier 50 sufficiently long. To eliminate sag in the wires 78a and 78b in the expanded state, there are provided springs 78k and 78m that vertically pull the wires 78a and 78b by way of the pulley mechanisms 78e and 78f The force that these springs 78k and 78m exert is not so strong as to disengage the snap mechanism.

It is possible to move the barrier 50 with the stepping motor 71 for moving the movable lenses of the zoom lens group 44 by diverting the driving force exerted by the motor 71 to the barrier 50. However, this complicates the structure, and in addition makes the opening and closing of the barrier 50 subject to restrictions imposed by the position of the movable lenses of the zoom lens group 44. By contrast, the barrier driver 78 has a simple structure, and permits the barrier 50 to be opened and closed utterly independently of the driving of the zoom lens group 44.

As shown in FIG. 6, the digital camera 1 is provided with a flash circuit 81 that controls the light emission by the flash emitter 14, an operation portion 82 including the various members (such as the main switch 16) described earlier that are operated by the user, a VRAM 83 in which to store the image data of the image to be displayed on the display 17, a card interface (I/F) 85 that handles input to and output from a memory card 84, a communication interface 86 that handles communication with an external device, and a battery 87 that supplies electric power to portions of the camera that operate on electric power. The controller 90, which controls the operation of the digital camera 1 as a whole, includes a CPU 91 as the main agent of control, a program memory 92 in which processes to be performed by the CPU 91 to achieve control are stored in the form of a program, and a parameter memory 93 in which parameters to be used by the CPU 91 to achieve control are stored.

The parameters stored in the parameter memory 93 include the relationship between the position of the movable lenses of the zoom lens group 44 and the shooting magnification and the relationship between the distance to the shooting target, the shooting magnification, and the position of the focus lens group 45. The digital camera 1 adopts automatic focus adjustment of the servo type whereby the focus lens group 45 is moved in the direction in which the contrast of the image sensed by the image sensor 30 increases until eventually the focus lens group 45 is positioned where the maximum contrast is obtained. To achieve automatic focus adjustment, the controller 90 evaluates contrast on the basis of the image data in the image memory 66.

After the taking optical system 40 is focused on the shooting target, when the user gives a command to perform zooming, i.e., to vary the shooting magnification, the controller 90 makes the zoom controller 72 move the movable lenses of the zoom lens group 44 and also makes the focus controller 76 move the focus lens group 45 so that the taking optical system 40 is kept focused on the shooting target. Here, the relationship between the distance to the shooting target, the magnification, and the position of the focus lens group 45 stored in the parameter memory 93 is referred to in order to position the focus lens group 45 at an appropriate position.

The digital camera 1 is capable of, in addition to optical zooming by the taking optical system 40, electronic zooming whereby the shooting magnification is increased by extracting part of the image data generated by the image processor 60. The shooting magnification can be increased by electronic zooming independently of the shooting magnification set by optical zooming, i.e., at any shooting magnification. However, electronic zooming lowers the resolution of the image, and therefore the digital camera 1 is so configured as to perform electronic zooming only when the optical shooting magnification is at its maximum. The zoom ratio (the ratio of the maximum shooting magnification to the minimum shooting magnification) of the taking optical system 40 is, for example, three, and the maximum increase factor by which the shooting magnification can be increased by electronic zooming is, for example, two.

In the digital camera 1, when the camera stops being used, i.e., when it stops operating, the settings related to zooming at that moment are retained, and, when the camera starts being used, it starts operating again with the settings with which it stopped being used previously. Specifically, when camera operation is stopped, the movable lenses of the zoom lens group 44 are kept in the position in which they are at that moment, and this position and the shooting magnification increase factor by electronic zooming are stored in the parameter memory 93. When camera operation is started, the position of the movable lenses of the zoom lens group 44 and the shooting magnification increase factor by electronic zooming are read out from the parameter memory 93 and are used to control zooming.

In this way, by keeping the zoom lens group 44 from moving when camera operation stops or starts, it is possible to reduce the time required after the main switch 16 is operated to stop camera operation until the camera actually stops operating, and also to reduce the time required after the main switch 16 is operated to start camera operation until the camera is actually ready to shoot.

Among a plurality of processes that need to be performed to stop camera operation, the digital camera 1 performs the process of closing the barrier 50 with the highest priority, and then performs the process of extinguishing the display on the display 17 with the second highest priority to the process of closing the barrier 50. Thus, the digital camera 1 promptly assumes the appearance that it is supposed to assume when out of operation. It is after the digital camera 1 has assumed this out-of-operation appearance that it performs other, internal, processes to eventually stop the supply of electric power from the battery 87. The internal processes include, for example, the process of recording on the memory card 84 image data that has not yet been recorded, the process of terminating communication by the communication interface 86, and the process of storing in the parameter memory 93 the movable lens position of the zoom lens group 44 and the shooting magnification increase factor by electronic zooming.

By performing the process of closing the barrier 50 first, it is possible to permit the user to put the digital camera 1 in a case or bag immediately after operating the main switch 16 to give a command to stop camera operation. In this case, after being put in the case or the like, the digital camera 1 performs the internal processes to eventually stop camera operation. The process of extinguishing the display on the display 17 is performed with the second highest priority to the process of closing the barrier 50, but is started without waiting for the completion of the movement of the barrier 50. Thus, in reality, the process of extinguishing the display on the display 17 proceeds parallel with the process of closing the barrier 50.

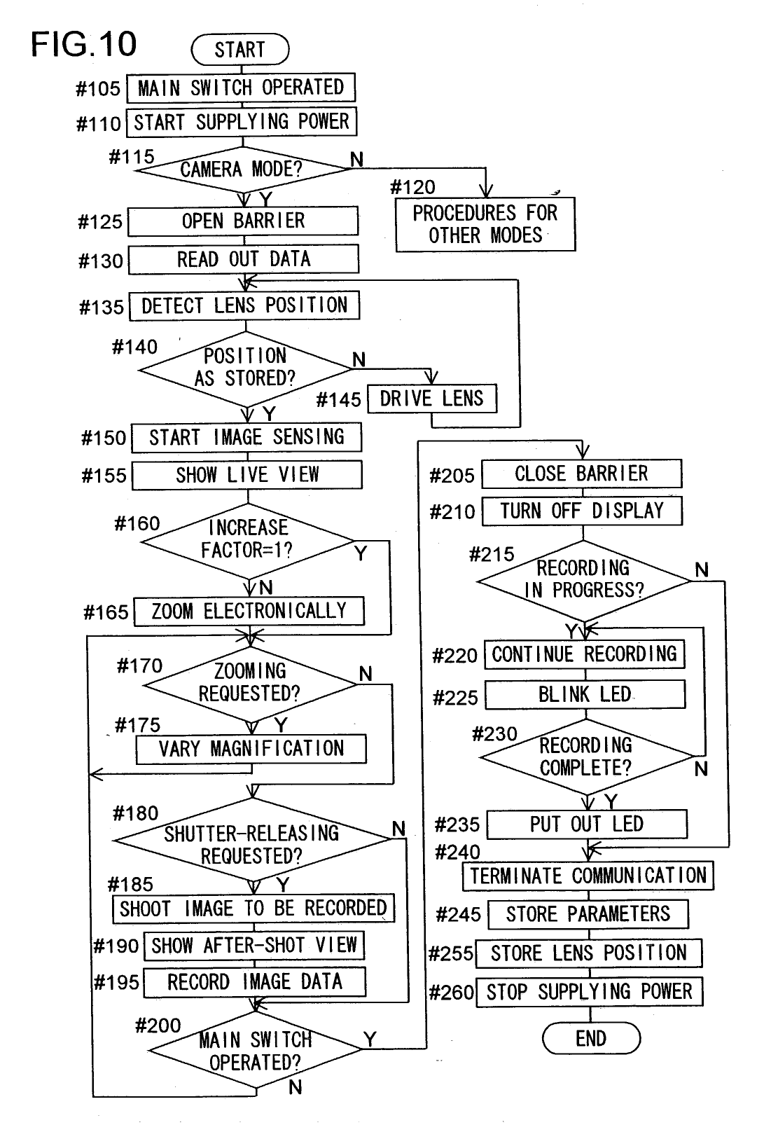

FIG. 10 is a flow chart showing an outline of the flow of processes performed in the camera mode for taking still pictures in the digital camera 1, starting with start-up and ending with shut-down. When, with the digital camera 1 out of operation, the main switch 16 is operated (step #105), electric power starts being supplied from the battery 87 to various portions of the digital camera 1 (#110). Next, what operation mode is selected by the operation switch 18 is checked (#115) and, if the selected operation mode is not the camera mode, the procedure for the movie mode or playback mode is performed (#120).

If the camera mode is selected, the barrier 50 is opened (#125), and the movable lens position of the zoom lens group 44 and the shooting magnification increase factor by electronic zooming are read out from the parameter memory 93 (#130). Then, the position of the movable lenses of the zoom lens group 44 is detected by the lens position detector 77 (#135), and whether or not the detected position coincides with the position read out from the parameter memory 93 is checked (#140). If they do not coincide, the movable lenses of the zoom lens group 44 are driven (#145) to position them in the position read out.

The reason that the processes in steps #135 to #145 are performed is that, while the digital camera 1 was out of operation, the position of the movable lenses of the zoom lens group 44 may have been changed slightly by physical shock applied to the digital camera 1. To detect the position of the movable lenses, the lens barrel 48 (FIG. 7) is rotated in one direction, and pulses in the output signal of the photoreflector 77a are counted until a blank period appears. To make the position of the movable lenses coincide with the position read out from the parameter memory 93, the stepping motor 71 is driven with as many pulses as corresponds to the difference between the reference position determined by one end of the blank period and the position read out from the parameter memory 93.

Next, image sensing by the image sensor 30 is started (#150), and the sensed image is displayed on the display 17 to provide a live view (#155). Then, whether or not the shooting magnification increase factor by electronic zooming as read out from the parameter memory 93 is one is checked (#160), and, if it is not one, electronic zooming is performed to make the actual increase factor equal to that read out from the parameter memory 93 (#165). Now, the digital camera 1 has restored the settings with which it finished shooting previously.

Thereafter, whether or not the operation key 19 is operated to give a command to perform zooming is checked (#170), and, if such a command is given, the shooting magnification is varied (#175), and then the flow returns to step #170. In this process performed in step #175, when the requested shooting magnification exceeds the maximum value of the optical shooting magnification, the increase factor by electronic zooming is varied, and otherwise the zoom lens group 44 is driven to vary the optical shooting magnification.

If, in step #170, no command to perform zooming is given, then whether or not the shutter-release button 15 is operated to give a command to record the image being sensed is checked (#180). If such a command is given, the image being sensed is shot as an image to be recorded (#185), and the image thus shot is displayed as an after-shot view on the display 17 (#190), and the image data representing that image starts being recorded on the memory card 84 (#195).

After the process in step #195, or if, in step #180, no command to record an image is given, then whether or not the main switch 16 is operated is checked (#200). If the main switch 16 is not operated, the flow returns to step #170. If the main switch 16 is operated, the barrier 50 is closed (#205), and the display on the display 17 is extinguished (#210). Now, the digital camera 1 has assumed the out-of-operation appearance.

Next, whether or not the recording of image data started in step #195 is still in progress or not is checked (#215). If the recording of image data is still in progress, it is continued (#220), and the LED lamp 22 (FIG. 2) is blinked to indicate that image data recording is in progress (#225). Next, whether or not image data recording is complete is checked (#230) so that, if it is incomplete, the flow returns to step #220, and, if it is complete, the LED lamp 22 is put out (#235). In this way, the LED lamp 22 serves as an indicator that permits the user to recognize that the digital camera 1 is still operating internally despite assuming the out-of-operation appearance. This helps prevent the user from prematurely taking out the memory card with image data recorded incompletely.

After step #235, or if, in step #215, the recording of image data is no longer in progress, then communication by the communication interface 86 is terminated (#240), and various parameters are stored in the parameter memory 93 (#245). Moreover, the position of the movable lenses of the zoom lens group 44 and the shooting magnification increase factor by electronic zooming at that moment are stored in the parameter memory 93 (#255), and then the electric power from the battery 87 stops being supplied (#260). Now, the digital camera 1 has stopped operating.

Also when, in step #120, the procedure for the movie mode or playback mode is performed, whether or not the main switch 16 is operated is checked, as in step #200, with appropriate timing so that, if the main switch 16 is operated, the processes in steps #205 and afterward are performed. Thus, in these operation modes also, when camera operation is stopped, the process of closing the barrier 50 is performed with the highest priority, and the process of extinguishing the display on the display 17 is performed with the second highest priority to that, so that the digital camera 1 first assumes the out-of-operation appearance and then performs internal processes.

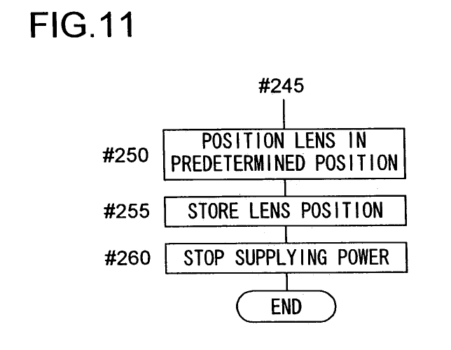

Subsequently to step #245, the processes shown in FIG. 11 may be performed instead. Specifically, the movable lenses of the zoom lens group 44 are moved to or close to the nearest of a plurality of reference positions (#250), and their position after this movement is stored in the parameter memory 93 (#255). This alternative permits the processes in step #135 to #145 at start-up to be performed in less time.

The movable lenses of the zoom lens group 44 may have only one reference position. In that case, however, it takes longer time to perform the processes in steps #135 to #145 or the process in step #250 than where a plurality of reference positions are set as in the digital camera 1 of this embodiment. In a case where only one reference position is set, to minimize on an average basis the time required to perform the processes in those steps, it is advisable to set the reference position at the position corresponding to the precisely middle shooting magnification between the minimum and maximum shooting magnifications, or at the position corresponding to the shooting magnification that the user uses most frequently.

Here, the LED lamp 22 keeps giving the indication only while recording of image data is in progress after the barrier 50 has been closed. However, the flow may be so modified that the LED lamp 22 keeps giving the indication after the barrier 50 is closed in step #205 until immediately before electric power stops being supplied in step #260. This helps prevent the user from removing the battery 87 before the internal processes are complete in a case where the battery 87 is of the rechargeable type and needs to be charged in the state detached from the digital camera 1. Moreover, the user can confirm that the operation of the main switch 16 that he or she has done to give a command to stop camera operation has been recognized by the digital camera 1, i.e., that the internal operation of the camera is going to stop shortly. Thus, the user can assuredly put the digital camera 1 in a case or the like.

Whether or not to give the indication by the LED lamp 22 can be chosen by the user by operating the operation buttons 20 while the digital camera 1 is operating. Instead of the LED lamp 22, a buzzer may be provided so as to be sounded to indicate that the processes for stopping camera operation are in progress.

In the digital camera 1 of this embodiment, the lens position detector 77 is structured as shown in FIG. 7. However, it may have any other structure. For example, it is possible to dispose a rotary encoder (chopper) as part of the gear train between the stepping motor 71 for moving the movable lenses of the zoom lens group 44 and the lens barrel 48, and detect the rotation of the rotary encoder with a photointerruptor. Alternatively, it is possible to provide the lens barrel 48 with two-phase reflective patterns, provide a photoreflector 77a for each of the reflective patterns, and use one of them to detect a reference position and the other to count pulses. Alternatively, it is possible to provide the lens barrel 48 with an electrically conductive pattern instead of the reflective pattern, provide an electrically conductive piece that makes contact with the electrically conductive pattern, and achieve detection electrically.

Obviously, many modifications and variations of the present invention are possible in light of the above teachings. It is therefore to be understood that within the scope of the appended claims, the invention may be practiced other than as specifically described.

What is claimed is:

1. A camera comprising:
an image-sensing portion for sensing an image;
a taking optical system for directing light to the image-sensing portion;
an operation portion for accepting a command to start camera operation and a command to stop camera operation;
an openable-closable shielding member that is closed when the camera is out of operation so as to shield a front face of the taking optical system; and
a controller portion that, when a command to stop camera operation is given while the camera is in operation, performs a plurality of processes for stopping camera operation including a process of closing the shielding member,
wherein the controller portion performs, among the plurality of processes for stopping camera operation, the process of closing the shielding member with highest priority.

2. A camera as claimed in claim 1,
wherein the taking optical system includes a turning optical system that reflects light and thereby turns an optical path substantially at a right angle and a zoom optical system that is disposed between the turning optical system and the image-sensing portion and that varies shooting magnification.

3. A camera as claimed in claim 1, further comprising:
an indicator portion that, when the processes for stopping camera operation are being performed, indicates that the processes for stopping camera operation are being performed.

4. A camera as claimed in claim 1, further comprising:
a display portion for achieving predetermined display when the camera is in operation,
wherein the controller portion performs, among all the processes for stopping camera operation, a process of stopping the display on the display portion parallel with the process of closing the shielding member or with second highest priority to the process of closing the shielding member.

5. A camera as claimed in claim 1,
wherein the plurality of processes for stopping camera operation which are performed by the controller portion include a process of completing recording of image data representing a taken picture on a recording medium or a process of terminating communication with an external device.

6. A camera as claimed in claim 1, further comprising:
a power supply portion for supplying electric power to portions of the camera that operate on electric power,
wherein the operation portion includes a main switch for accepting a command to start and a command to stop supply of electric power from the power supply portion.

7. A camera that has different appearances between when in operation and when out of operation, comprising:
an image-sensing portion for sensing an image;
a taking optical system for directing light to the image-sensing portion;
an operation portion for accepting at least a command to stop camera operation;
a controller portion that, when a command to stop camera operation is given while the camera is in operation, performs a plurality of processes for stopping camera operation,
wherein the controller portion performs, among the plurality of processes for stopping camera operation, a process that brings about a change in appearance with highest priority, and then, after the camera has assumed an appearance that the camera is designed to assume when out of operation, performs one or more processes that bring about no change in appearance.

8. A camera as claimed in claim 7,
wherein the taking optical system includes a turning optical system that reflects light and thereby turns an optical path substantially at a right angle and a zoom optical system that is disposed between the turning optical system and the image-sensing portion and that varies shooting magnification.

9. A camera as claimed in claim 7, further comprising:
an indicator portion that, when the processes for stopping camera operation are being performed, indicates that the processes for stopping camera operation are being performed.

10. A camera as claimed in claim 7,
wherein the controller portion performs the process that brings about a change in appearance parallel with part of the processes that bring about no change in appearance.

11. A camera as claimed in claim 7, further comprising:
a power supply portion for supplying electric power to portions of the camera that operate on electric power,
wherein the operation portion includes a main switch for accepting a command to start and a command to stop supply of electric power from the power supply portion.

12. A digital camera comprising:
an image sensor for sensing an image;
a taking optical system for directing light to the image sensor, the taking optical system including a turning optical system for turning an optical path and a zoom optical system, disposed between the turning optical system and the image sensor, for varying shooting magnification;
a driver portion for driving a movable lens of the zoom optical system;
a storage portion for storing a position of the movable lens of the zoom optical system;
an operation portion for accepting a command to start shooting operation and a command to stop shooting operation; and
a controller portion for controlling the driver portion to drive the movable lens of the zoom optical system while detecting the position of the movable lens of the zoom optical system,
wherein, when a command to stop shooting operation is given, the controller portion makes the storage portion store the position of the movable lens at that time point, and, when a command to start shooting operation is given, the controller portion controls driving of the movable lens according to the position stored in the storage portion.

13. A camera as claimed in claim 12, further comprising:
a power supply portion for supplying electric power to portions of the camera that operate on electric power,
wherein the operation portion includes a main switch for accepting a command to start and a command to stop supply of electric power from the power supply portion.
